(19) United States
(12) Patent Application Publication
(10) Pub. No.: US 2004/0154608 A1
(43) Pub. Date: Aug. 12, 2004

(54) Pivoting side shelf for a barbecue grill

(76) Inventors: Gregg T. Ward, Joplin, MO (US); Randy L. Hobart, Joplin, MO (US); Paul E. Cole, Neosho, MO (US)

Correspondence Address: MARTIN & ASSOCIATES, LLC, P O BOX 548, CARTHAGE, MO, 64836-0548, US

(21) Appl. No.: 10/365,625

(22) Filed: Feb. 12, 2003

(51) Int. Cl. A47J 37/00

(52) U.S. Cl. 126/41 R; 126/38; 126/39 B

(57) ABSTRACT

A side shelf for a cooking grill includes a base coupled to the grill and a cover that pivots with respect to the base to substantially cover the base in a first position and to substantially uncover the base in a second position. In a first embodiment, the cover is coupled to the base using a plurality of pivot arms that maintain the cover in a substantially horizontal position while the cover is moved from the first position to the second position. In the first embodiment, the cover includes a substantially flat top portion that is up in both the first and second positions, which allows the cover to be used as a shelf both in the first and second positions. In a second embodiment, the cover is coupled to the base using at least one hinge member that allows the cover to pivot in a clamshell fashion with respect to the base. In the second embodiment, the cover includes a substantially flat top portion that is up in the first position, and a substantially flat bottom portion that is up in the second position. Third and fourth embodiments provide pivot points that allow the cover to pivot in a sideways fashion with respect to the base. The pivoting shelf cover of the preferred embodiments increases work space by allowing the cover to be used as a sturdy side shelf when the cover is in the second position.

### BACKGROUND OF THE INVENTION

1. Technical Field

The present invention relates to barbecue grills. More particularly the invention relates to a side shelf for a barbecue grill.

2. Background Art

The backyard barbecue is a long established summer pastime in the United States. Gas grills have become very popular because they eliminate the mess and hassle of dealing with charcoal and lighter fluid. A wide variety of designs for gas grills has emerged. Side shelves and side burners have become commonplace on many known gas grills. A side shelf provides work space relatively close to the cooking surface of the grill where a person may place platters of meat, spices, sauces, etc. A side burner allows cooking in pans in addition to cooking on the cooking surface of the grill. In this manner, a person using a gas grill with a side burner could steam corn on the cob using a pan on the side burner at the same time that steaks are cooking on the cooking surface of the grill.

Some side shelves include burner covers. For example, the following U.S. Patents all disclose a hinged cover for a side burner: U.S. Pat. No. 5,490,494 issued on Feb. 13, 1996 to Giebel et al.; U.S. Pat. No. 4,886,045 issued on Dec. 12, 1989 to Ducate, Jr. et al.; and U.S. Pat. No. 4,677,964 issued on Jul. 7, 1987 to Lohmeyer et al. Each of these hinged covers are opened approximately 90 degrees to use the side burner, which results in the hinged cover extending upward when the burner is in use. None of these patents disclose a burner cover that can be used as a work surface when the cover is in the open position.

U.S. Pat. No. 6,308,616 issued on Oct. 30, 2001 to Johnson shows a sliding shelf that serves as a burner cover. The Johnson burner cover may be used as a work shelf in both the open and closed position, but it requires a track and roller system that may become fouled with food or sauce drippings during ordinary use of the grill. What is needed is a simple side shelf with a pivoting cover that is much simpler to produce than the Johnson sliding shelf while providing a sturdy work surface that is substantially horizontal in both the open and closed positions.

### DISCLOSURE OF INVENTION

A side shelf for a cooking grill includes a base coupled to the grill and a cover that pivots with respect to the base to substantially cover the base in a first position and to substantially uncover the base in a second position. In a first embodiment, the cover is coupled to the base using a plurality of pivot arms that maintain the cover in a substantially horizontal position while the cover is moved from the first position to the second position. In the first embodiment, the cover includes a substantially flat top portion that is up in both the first and second positions, which allows the cover to be used as a shelf both in the first and second positions. In a second embodiment, the cover is coupled to the base using at least one hinge member that allows the cover to pivot in a clamshell fashion with respect to the base. In the second embodiment, the cover includes a substantially flat top portion that is up in the first position, and a substantially flat bottom portion that is up in the second position. Third and fourth embodiments provide pivot points that allow the cover to pivot in a sideways fashion with respect to the base. The pivoting shelf cover of the preferred embodiments increases work space by allowing the cover to be used as a side shelf when the cover is in the second position.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a perspective view of a side shelf in accordance with a first embodiment of the present invention with the cover in a closed position;

FIG. 2 is a perspective view of the side shelf of FIG. 1 with the cover in a first partially open position;

FIG. 3 is a perspective view of the side shelf of FIG. 1 with the cover in a second partially open position;

FIG. 4 is a perspective view of the side shelf of FIG. 1 in a fully open position;

FIG. 5 is a front view of the side shelf shown in FIGS. 1-4 when the side shelf is in the fully open position;

FIG. 6 is a top view of the side shelf shown in FIGS. 1-5 when the side shelf is in the fully open position;

FIG. 7 is an exploded perspective view of the side shelf in FIGS. 1-6;

FIG. 7A is a cross-sectional view of the pivotal coupling between the pivot arm 130A and the base 120 in FIG. 7;

FIG. 8 is a perspective view of a grill that includes the side shelf of FIGS. 1-7 in accordance with the first embodiment;

FIG. 9 is a perspective view of a side shelf in accordance with a second embodiment of the present invention with the cover in a closed position;

FIG. 10 is a perspective view of the side shelf of FIG. 9 with the cover in a first partially open position;

FIG. 11 is a perspective view of the side shelf of FIG. 9 with the cover in a second partially open position;

FIG. 12 is a perspective view of the side shelf of FIG. 9 in a fully open position;

FIG. 13 is a front view of the side shelf shown in FIGS. 9-12 when the side shelf is in the fully open position;

FIG. 14 is a top view of the side shelf shown in FIGS. 9-13 when the side shelf is in the fully open position;

FIG. 15 is an exploded perspective view of the side shelf in FIGS. 9-14;

FIG. 15A is a front view of the side shelf in FIGS. 9-15 showing a retention mechanism that holds the cover in the fully open position;

FIG. 16 is a perspective view of a grill that includes the side shelf of FIGS. 9-15 in accordance with the second embodiment;

FIG. 17 is a perspective view of a side shelf in accordance with a third embodiment of the present invention with the cover in a closed position;

FIG. 18 is a perspective view of the side shelf of FIG. 17 with the cover in a first partially open position;

FIG. 19 is a perspective view of the side shelf of FIG. 17 with the cover in a second partially open position;

FIG. 20 is a perspective view of the side shelf of FIG. 17 in a fully open position;

FIG. 21 is a front view of the side shelf shown in FIGS. 17-20 when the side shelf is in the fully open position;

FIG. 22 is a top view of the side shelf shown in FIGS. 17-20 when the side shelf is in the fully open position;

FIG. 23 is a perspective view of a side shelf in accordance with a fourth embodiment of the present invention with the cover in a closed position;

FIG. 24 is a perspective view of the side shelf of FIG. 23 with the cover in a first partially open position;

FIG. 25 is a perspective view of the side shelf of FIG. 23 with the cover in a second partially open position;

FIG. 26 is a perspective view of the side shelf of FIG. 23 in a fully open position;

FIG. 27 is a front view of the side shelf shown in FIGS. 23-26 when the side shelf is in the fully open position; and

FIG. 28 is a top view of the side shelf shown in FIGS. 23-26 when the side shelf is in the fully open position.

### BEST MODE FOR CARRYING OUT THE INVENTION

The present invention provides a significant advantage over the known art by providing a side shelf for a barbecue grill that includes a cover that may be pivoted to an open position that is substantially horizontal so the cover may be used as a side shelf when the cover is open.

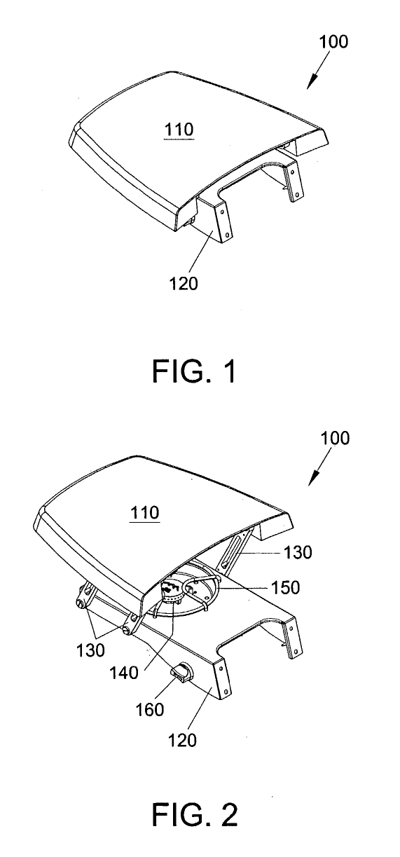

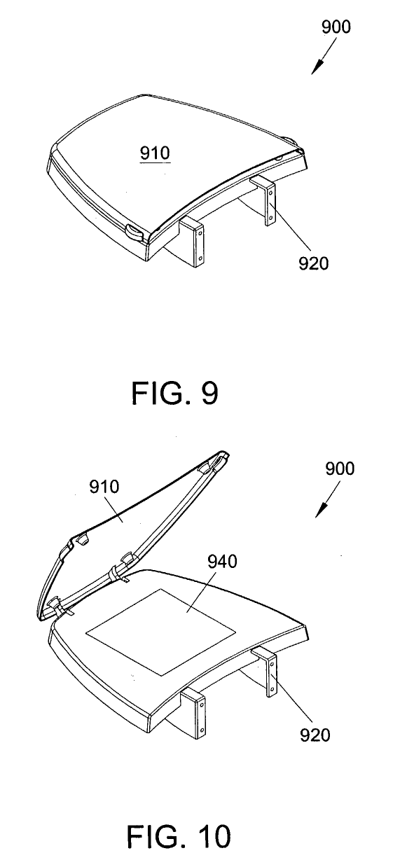

A first embodiment in accordance with the present invention is shown in FIGS. 1-8. A side shelf 100 includes a cover 110 pivotally coupled to a base 120. Cover 110 preferably includes a substantially flat top surface that may be used as a shelf. In the alternative, cover 110 may include only a portion of the top surface that is substantially flat. Base 120 is preferably fixedly attached to a barbecue grill. For example, base 120 may be affixed to a grill by welding or using fasteners such as screws or bolts. Base 120 may be any suitable configuration. For example, base 120 may provide a substantially flat shelf surface. In an alternative configuration within the scope of the first embodiment, base 120 may include a burner 140 and grate 150, as shown in FIGS. 2-4, 6 and 7. In this configuration, a burner knob 160 is used to control the flow of gas to the burner 140. In yet another configuration within the scope of the first embodiment, base 120 may include a storage container, as shown in more detail in the second embodiment in FIGS. 9-16.

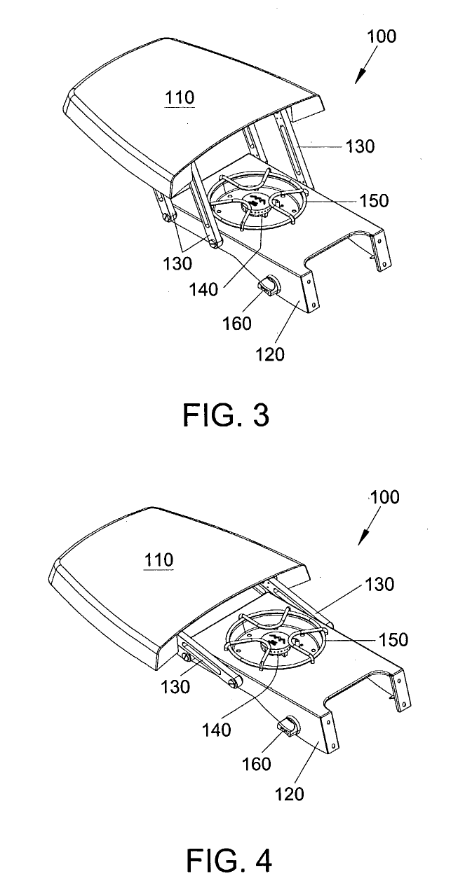

Cover 110 is coupled to the base 120 via a plurality of pivot arms 130 that each have one end pivotally coupled to the cover 110 and the other end pivotally coupled to the base 120. The action of moving the cover 110 from the closed position to the open position is shown by the progression from FIG. 1 to FIG. 4. FIG. 1 shows the cover 110 in the closed position, substantially covering the base 120. FIG. 2 shows the cover 110 in a partially open position, illustrating how the pivot arms allow the cover 110 to pivot with respect to the base 120. FIG. 3 shows the cover 110 in a more open position. And FIG. 4 shows the cover 110 in the fully open position. The cover may be deployed from the closed position in FIG. 1 to the open position in FIG. 4 by pushing the cover left, which causes the cover to initially move up as it moves left, then back down to its open position shown in FIGS. 4 and 6.

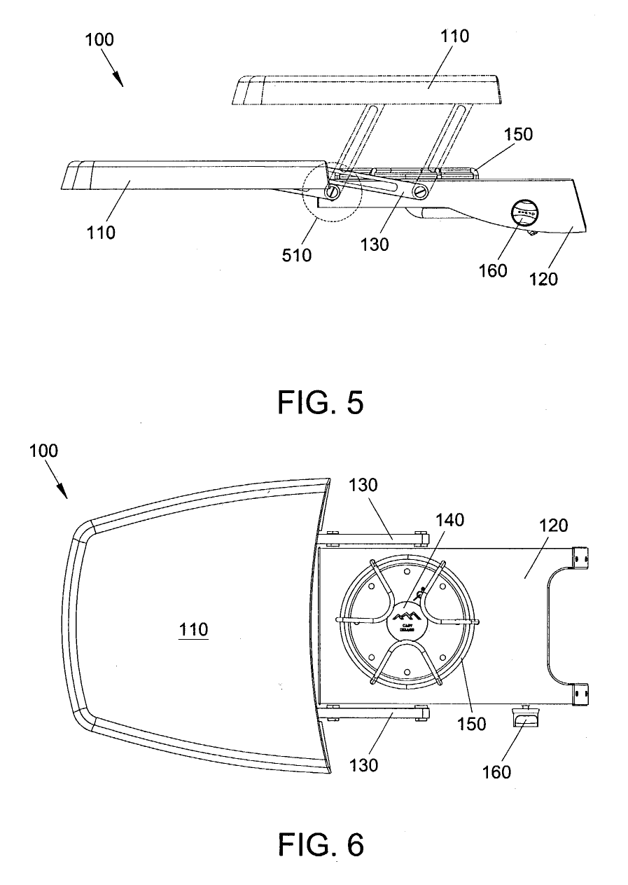

FIG. 5 is a front view of the side shelf 100 of the first embodiment. The cover 110 is shown in its fully open position, but is also shown in phantom in a partially open position to illustrate the movement of the cover 110 as it opens. FIG. 6 is a top view of the side shelf 100 in its fully open position.

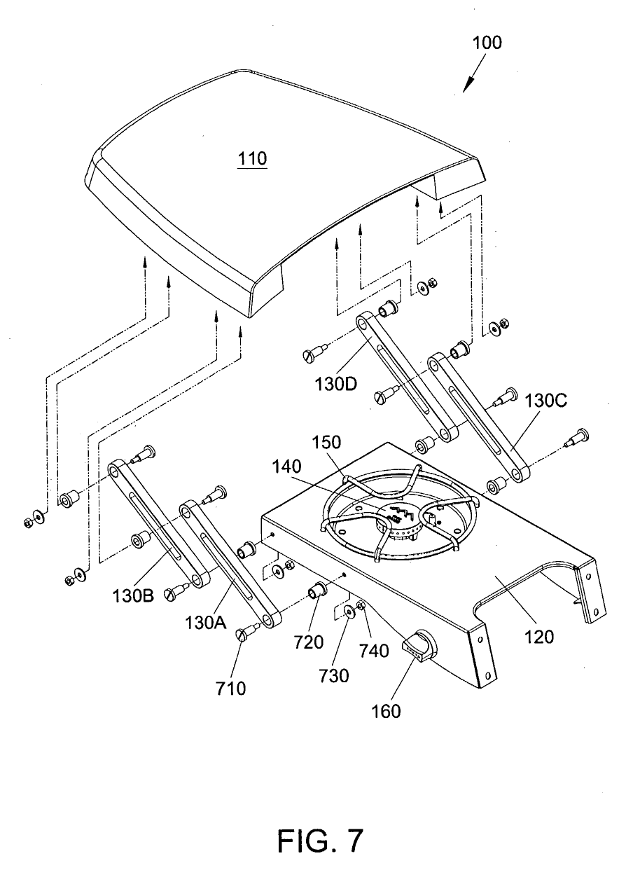

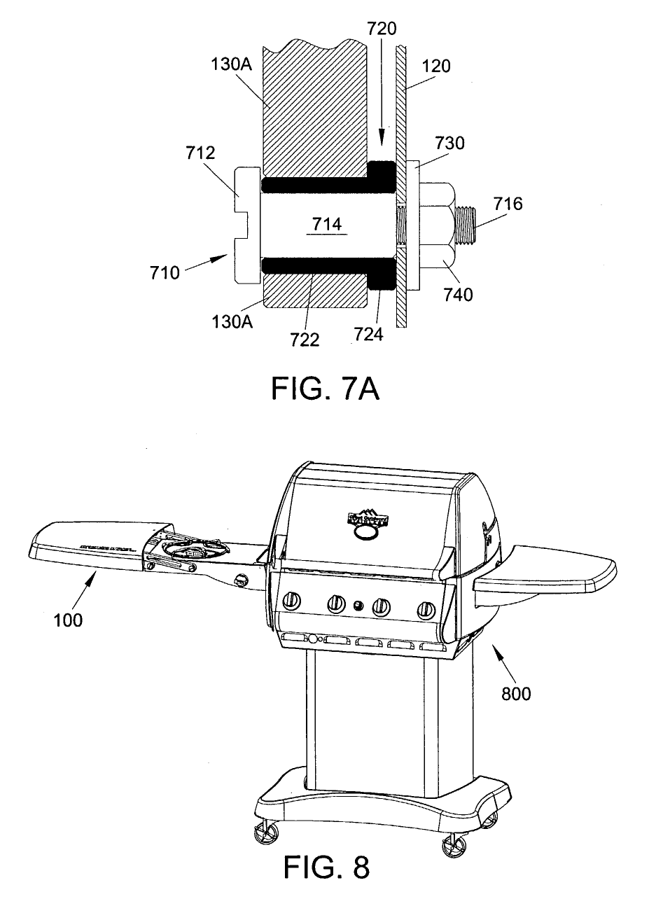

The details of the pivot arms and their coupling to the cover 110 and base 120 are shown in FIGS. 7 and 7A. Pivot arm 130A has a first end that is coupled to the base 120 using a shoulder screw 710, a bushing 720, a washer 730, and a nut 740. As shown in FIG. 7A, shoulder screw 710 includes a head 712, a smooth shaft 714, and a threaded portion 716. Threaded portion 716 passes through the bushing 720, the side face of the base 120, the washer 730, and the nut 740. Bushing 720 includes a reduced portion 722 and a shoulder 724. The shoulder 724 provides spacing between the pivot arm 130A and the base 120. In this manner the pivot arm 130A is pivotally coupled to base 120. Note that the pivot arms 130 may optionally include an enlarged portion for receiving the head 712 of shoulder screw 710 so the head 712 is flush with or recessed from the outside surface of pivot arm 130A. The length of the reduced portion 722 of bushing 720 is preferably greater than the length of the corresponding recess in the pivot arm 130A, causing the pivot arm 130A to easily pivot about the shoulder screw 710 even when the nut 740 is fully tightened on the threaded portion 716.

The first embodiment includes not only the side shelf 100, but a barbecue grill 800 that includes the side shelf 100, as shown in FIG. 8. While the side shelf 100 is shown in FIG. 8 on the left side of the barbecue grill, the preferred embodiments expressly extend to a shelf in any suitable position on the barbecue grill. In addition, while the side shelf 100 is shown to pivot sideways, it is equally within the scope of the first embodiment to have a side shelf 100 with a cover 110 that pivots to the front or rear. The first embodiment expressly extends to any and all shelves for a barbecue grill that include one or more pivot arms that allow a cover in a substantially horizontal closed position to move in a nonlinear fashion to a substantially horizontal open position.

The second embodiment is shown in FIGS. 9-16. The second embodiment comprises a side shelf 900 that includes a cover 910 pivotally coupled to a base 920. Cover 910 preferably includes a substantially flat top surface that may be used as a shelf. Base 920 is preferably fixedly attached to a barbecue grill. For example, base 920 may be affixed to a grill by welding or using fasteners such as screws or bolts. Base 920 may be any suitable configuration. For example, base 920 may provide a substantially flat shelf surface. In an alternative configuration within the scope of the second embodiment, base 920 may include a burner 140 and grate 150, as shown in FIGS. 4, 6 and 7 for the first embodiment. In yet another configuration within the scope of the second embodiment, base 920 may include a container 940. Container 940 could be a permanent part of base 120, or may be a separate container that fits within a recess or opening in base 120. Note that cover 110 could include a mating surface on its bottom side that mates with the container to seal the container when the cover 110 is in the closed position. The container could be insulated to keep drinks cold, or could be uninsulated for holding utensils, spices and the like. The preferred embodiments expressly extend to any type of container within base 120.

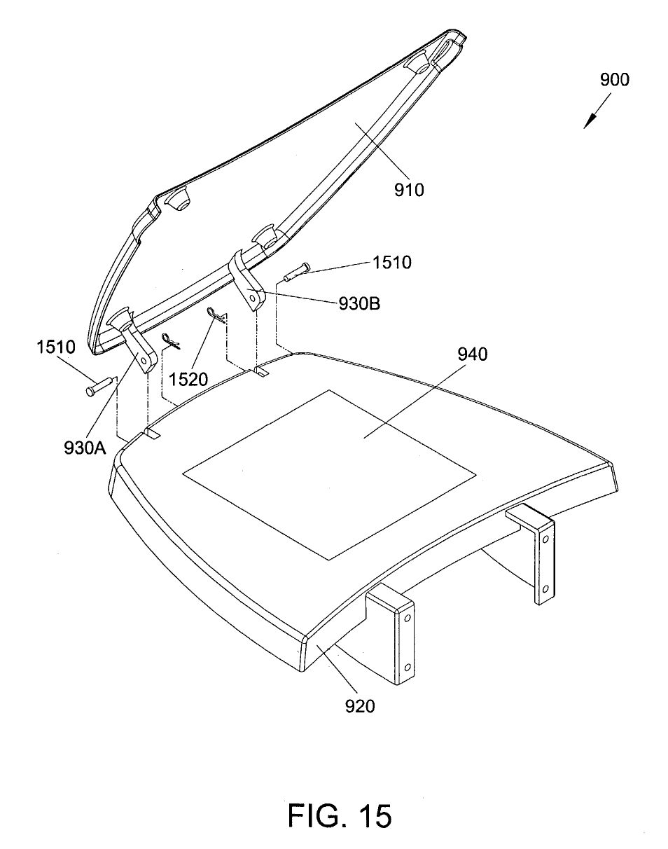

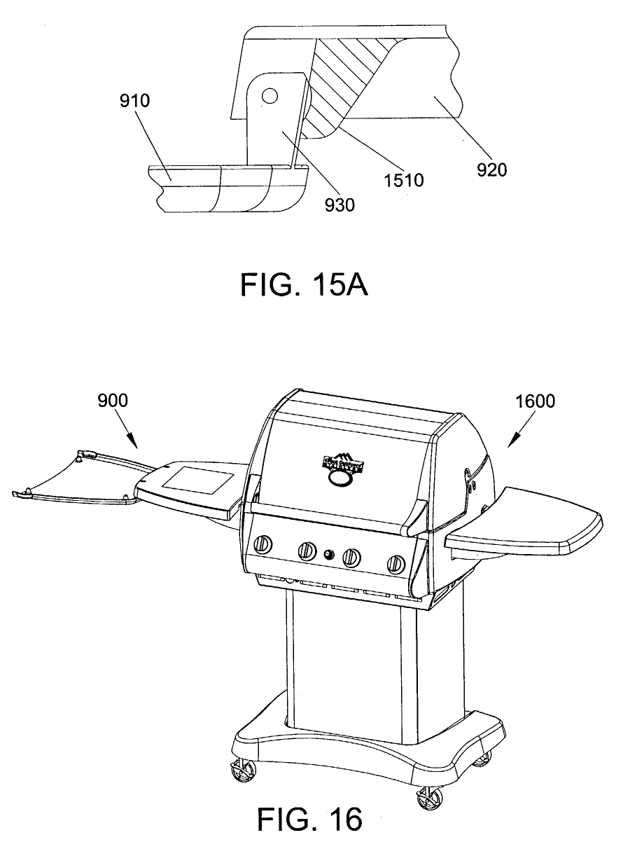

Cover 910 is coupled to the base 920 via one or more hinge members 930 that are fixedly coupled to one of the cover 910 and the base 920 and pivot with respect to the other. For the configuration shown in FIGS. 9-16, two hinge members 930A and 930B are attached to the cover 910 and are coupled to the base using pins 1510, as shown in FIG. 15. Each pin 1510 preferably includes a hole that receives a locking pin 1520 that retains the pin 1510 in place. The end of the pin 1510 is placed through a hole in base 920, through hinge member 930, then through a second hold in base 920. Locking pin 1520 is then placed in the hold in pin 1510, thereby holding pin 1510 in place. In this manner, the cover 910 may pivot in a clamshell fashion with respect to the base 920. Note that the term “clamshell fashion” is used herein in a broad sense to mean that cover 910 and base 920 are hinged together, regardless of whether or not the hinge is at the extreme edge of the cover and base.

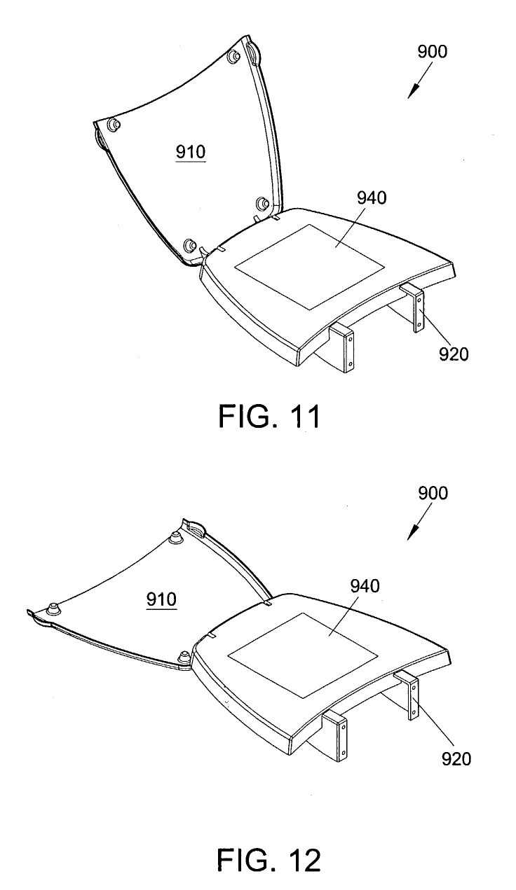

The action of pivoting the cover 910 from the closed position to the open position is shown by the progression from FIG. 9 to FIG. 12. FIG. 9 shows the cover 910 in the closed position, substantially covering the base 920. FIG. 10 shows the cover 910 in a partially open position, illustrating how the hinge members allow the cover 910 to pivot with respect to the base 920. FIG. 11 shows the cover 910 in a more open position. And FIG. 12 shows the cover 910 in the fully open position. The cover may be deployed from the closed position in FIG. 9 to the open position in FIG. 12 by providing a lifting and leftward force on cover 910, which causes the cover to pivot about the hinge members to its open position shown in FIGS. 12 and 14.

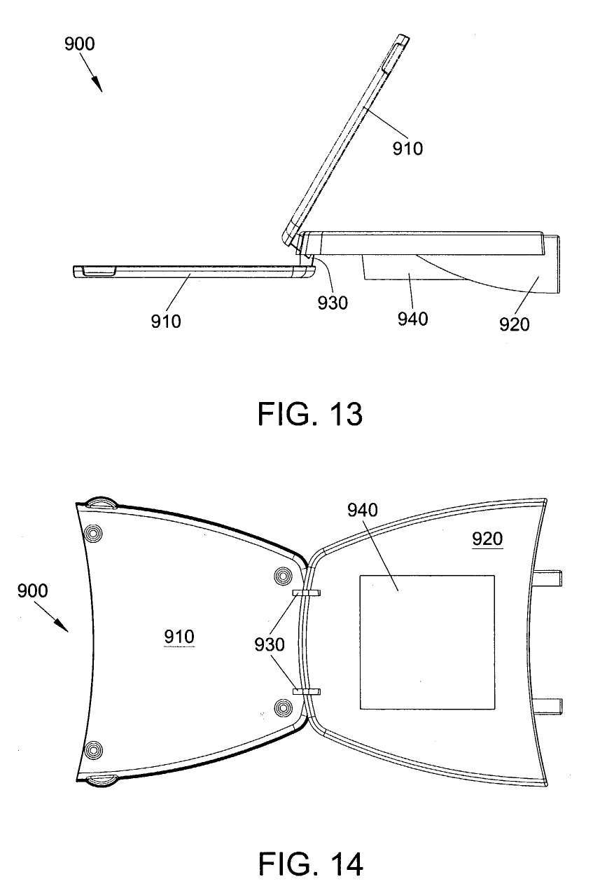

FIG. 13 is a front view of the side shelf 900 of the second embodiment. The cover 910 is shown in its fully open position, but is also shown in phantom in a partially open position to illustrate the movement of the cover 910 as it opens. FIG. 14 is a top view of the side shelf 900 in its fully open position.

The second embodiment includes not only the side shelf 900, but a barbecue grill 1600 that includes the side shelf 900, as shown in FIG. 16. While the side shelf 900 is shown in FIG. 16 on the left side of the barbecue grill, the preferred embodiments expressly extend to a shelf in any suitable position on the barbecue grill. In addition, while the side shelf 900 is shown to pivot sideways, it is equally within the scope of the second embodiment to have a side shelf 900 with a cover 910 that pivots to the front or rear. The second embodiment expressly extends to any and all shelves for a barbecue grill that include one or more hinge members that allow a cover in a substantially horizontal closed position to move in a nonlinear fashion to a substantially horizontal open position.

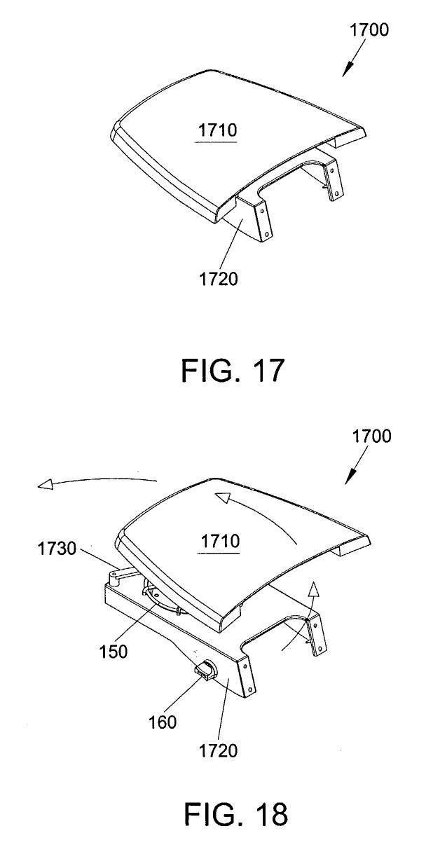

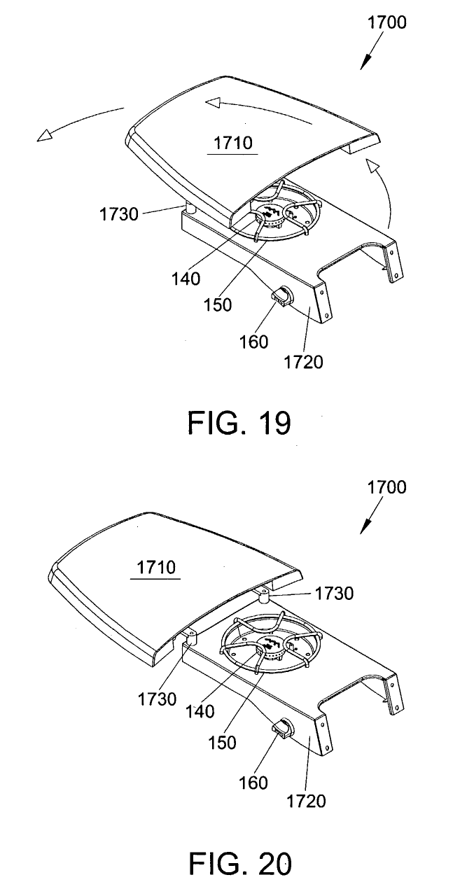

The third embodiment is shown in FIGS. 17-22. The third embodiment comprises a side shelf 1700 that includes a cover 1710 pivotally coupled to a base 1720. Cover 1710 preferably includes a substantially flat top surface that may be used as a shelf. Base 1720 is preferably fixedly attached to a barbecue grill. For example, base 1720 may be affixed to a grill by welding or using fasteners such as screws or bolts. Base 1720 may be any suitable configuration. For example, base 1720 may provide a substantially flat shelf surface. In an alternative configuration within the scope of the second embodiment, base 1720 may include a burner 140 and grate 150, as shown in FIGS. 19, 20 and 22. In yet another configuration within the scope of the second embodiment, base 1720 may include a container 940 as shown in FIGS. 10-14 and discussed above in reference to the second embodiment.

Cover 1710 is coupled to the base 1720 via one or more pivot arms 1730 that are movably coupled to the cover 1710 and the base 1720. For the configuration shown in FIGS. 17-22, two pivot arms 1730 are attached to the cover 1710 and are coupled to the base, as shown best in FIGS. 18, 20 and 22. Pivot arms 1730 could have a similar configuration to pivot arms 130 in the first embodiment, with the exception that pivot arms 1710 are preferably mounted in a sideways direction that allows the cover 1710 to pivot away from the base 1720 in a way that keeps the cover 1710 in substantially the same plane regardless of whether the cover is closed, partially open, or completely open.

The action of moving the cover 1710 from the closed position to the open position is shown by the progression from FIG. 17 to FIG. 20. FIG. 17 shows the cover 1710 in the closed position, substantially covering the base 1720. FIG. 18 shows the cover 1710 in a partially open position, illustrating how the pivot arms 1730 allow the cover 1710 to pivot with respect to the base 1720. FIG. 19 shows the cover 1710 in a more open position. And FIG. 20 shows the cover 1710 in the fully open position. The cover may be deployed from the closed position in FIG. 17 to the open position in FIG. 20 by providing a rearward pushing force on the front edge of cover 1710, which causes the cover to pivot about the pivot arms to its open position shown in FIG. 20.

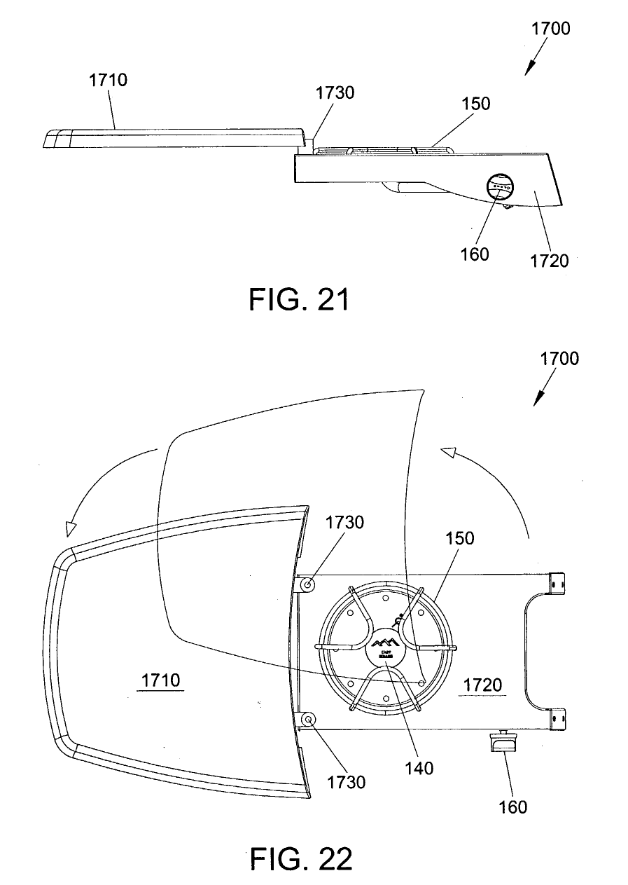

FIG. 21 is a front view of the side shelf 1700 of the third embodiment. FIG. 22 is a top view of the side shelf 1700 in its fully open position. The cover 1710 is shown in its fully open position, but is also shown in phantom in a partially open position to illustrate the movement of the cover 1710 as it opens.

The third embodiment includes not only the side shelf 1700, but a barbecue grill that includes the side shelf 1700. The preferred embodiments expressly extend to a shelf in any suitable position on the barbecue grill. In addition, while the side shelf 1700 is shown to pivot to the rear, it is equally within the scope of the second embodiment to have a side shelf 1700 with a cover 1710 that pivots to the front. The third embodiment expressly extends to any and all shelves for a barbecue grill that include one or more pivot arms that allow a cover in a substantially horizontal closed position to pivot in the same plane to a substantially horizontal open position.

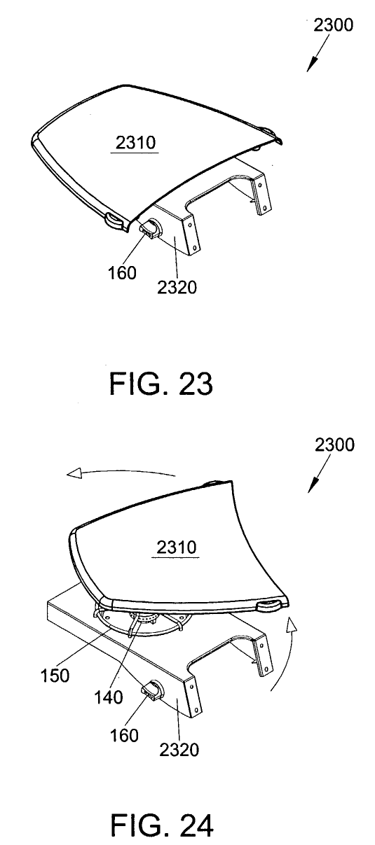

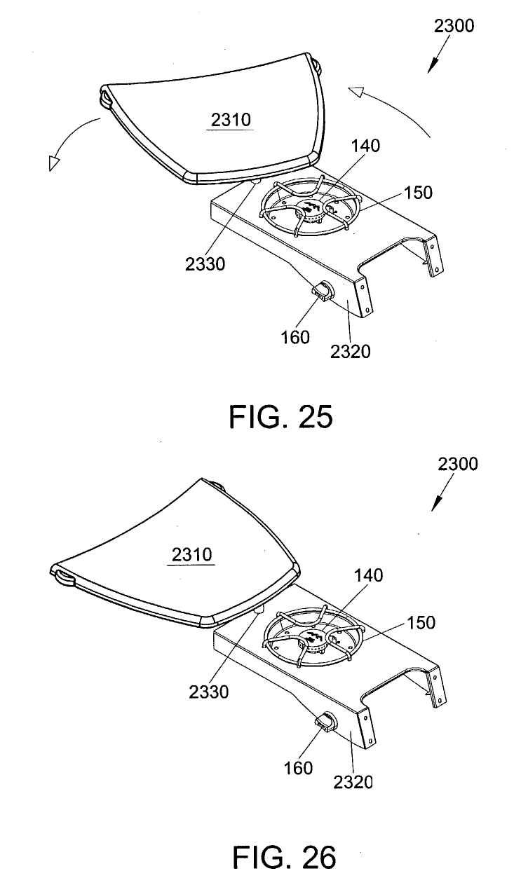

The fourth embodiment is shown in FIGS. 23-28. The fourth embodiment comprises a side shelf 2300 that includes a cover 2310 pivotally coupled to a base 2320. Cover 2310 preferably includes a substantially flat top surface that may be used as a shelf. Base 2320 is preferably fixedly attached to a barbecue grill. For example, base 2320 may be affixed to a grill by welding or using fasteners such as screws or bolts. Base 2320 may be any suitable configuration. For example, base 2320 may provide a substantially flat shelf surface. In an alternative configuration within the scope of the second embodiment, base 2320 may include a burner 140 and grate 150, as shown in FIGS. 25, 26 and 28. In yet another configuration within the scope of the second embodiment, base 2320 may include a container 940 as shown in FIGS. 10-14 and discussed above in reference to the second embodiment.

Cover 2310 is coupled to the base 2320 via a single pivot pin 2330 that connects the cover 2310 to the base 2320. Pivot pin 2330 allows cover 2310 to pivot in a planar fashion with respect to the base 2320 in a way that keeps the cover 2310 in substantially the same plane regardless of whether the cover is closed, partially open, or completely open.

The action of moving the cover 2310 from the closed position to the open position is shown by the progression from FIG. 23 to FIG. 26. FIG. 23 shows the cover 2310 in the closed position, substantially covering the base 2320. FIG. 24 shows the cover 2310 in a partially open position, illustrating how the pivot pin 2330 allows the cover 2310 to pivot with respect to the base 2320. FIG. 25 shows the cover 2310 in a more open position. And FIG. 26 shows the cover 2310 in the fully open position. The cover may be deployed from the closed position in FIG. 23 to the open position in FIG. 26 by providing a rearward pushing force on the front edge of cover 2310, which causes the cover to pivot about the pivot pin 2330 to its open position shown in FIGS. 26 and 28.

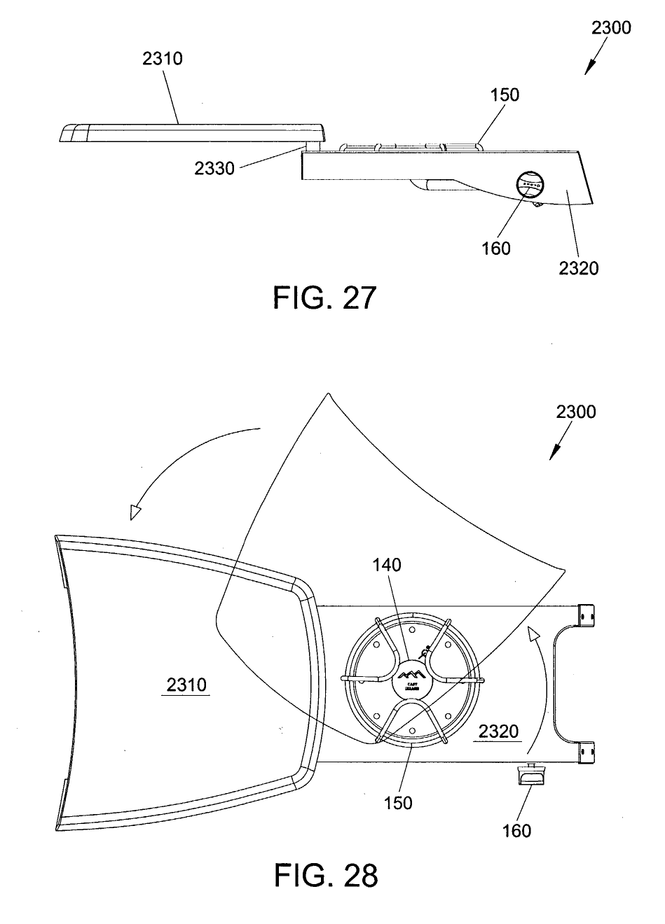

FIG. 27 is a front view of the side shelf 2300 of the fourth embodiment. FIG. 28 is a top view of the side shelf 2300 in its fully open position. The cover 2310 is shown in its fully open position, but is also shown in phantom in a partially open position to illustrate the movement of the cover 2310 as it opens.

The fourth embodiment includes not only the side shelf 2300, but a barbecue grill that includes the side shelf 2300. The preferred embodiments expressly extend to a shelf in any suitable position on the barbecue grill. In addition, while the side shelf 2300 is shown to pivot to the rear, it is equally within the scope of the second embodiment to have a side shelf 2300 with a cover 2310 that pivots to the front or to the side, or to a cover 2310 that pivots 90 degrees instead of a full 180 degrees shown in FIGS. 23-28. The fourth embodiment expressly extends to any and all shelves for a barbecue grill that include a single pivot pin that allows a cover in a substantially horizontal closed position to pivot in the same plane to a substantially horizontal open position.

Note that the pivotal coupling between the cover and the base preferably provides a retention mechanism that holds the cover in a substantially horizontal position. For the first embodiment, this retention mechanism may be seen in the dotted circle in FIG. 5, where one pivot arm rests against the other pivot arm when the cover 110 is in the fully open position. This provides a very strong structural support for cover 110, which allows the cover 110 to be used as a side shelf. For the second embodiment, this retention mechanism may be seen in FIG. 15A. Base 920 preferably includes a stop member 1510 that hinge member 930 rests against when in the fully open position. The retention mechanism 1510 thus holds the cover in a substantially horizontal position when the cover is in the open position. The third and fourth embodiments may also include appropriate retention mechanisms to hold the cover in the open position.

In the first, third and fourth embodiments, the cover preferably includes a substantially flat top surface. In the second embodiment, the cover preferably includes a substantially flat top surface and a substantially flat bottom surface. Note, however, that the entire top or bottom of the cover need not be substantially flat. The preferred embodiments expressly extend to configurations for the cover where only a portion of the top surface or bottom surface is substantially flat. In addition, a substantially flat surface is not strictly necessary to practice the present invention. A side shelf could have a washboard-type surface, with peaks and valleys. If these peaks and valleys lie in a plane, the cover may be effectively used as a work surface when in the open position, even though the cover is not substantially flat. The preferred embodiments expressly extend to any configuration for the side shelf cover, whether substantially flat, whether it has only a portion that is substantially flat, or whether it has a surface that is not substantially flat.

In the prior art, hinged burner covers are provided to cover a side burner when not in use. The burner cover is moved to uncover a burner, but serves no useful function when open. The preferred embodiments, in contrast, provide a side shelf for a barbecue grill that includes a cover that may be pivoted to an open position that is substantially horizontal. By providing a sturdy mechanical coupling that supports the cover in the substantially horizontal position, the cover may be used as a side shelf when the cover is open.

While the invention has been particularly shown and described with reference to preferred embodiments thereof, it will be understood by those skilled in the art that various changes in form and details may be made therein without departing from the spirit and scope of the invention.

We claim:

1. A side shelf for a barbecue grill comprising:
a base coupled to the barbecue grill; and
a cover pivotally coupled to the base that pivots between a first position that substantially covers the base and a second position that substantially uncovers the base, wherein the cover in both the first and second positions is substantially horizontal.

2. The side shelf of claim 1 wherein the base includes a gas burner.

3. The side shelf of claim 1 wherein the base includes a storage container.

4. The side shelf of claim 1 wherein the cover includes a substantially flat top that may be used as a shelf in the first and second positions.

5. The side shelf of claim 1 wherein the pivotal coupling between the cover and the base comprises at least one hinge member that allows the cover to pivot in a clamshell fashion with respect to the base.

6. The side shelf of claim 5 wherein the cover includes a substantially flat top portion that faces up when the cover is in the first position and a substantially flat bottom portion that faces up when the cover is in the second position.

7. The side shelf of claim 1 wherein the pivotal coupling between the cover and the base comprises at least one pivot arm having a first end pivotally coupled to the base and having a second end pivotally coupled to the cover.

8. The side shelf of claim 7 wherein the cover includes a top surface that faces up when the cover is in the first and second positions.

9. The side shelf of claim 1 further comprising a retention mechanism that holds the cover in the second position.

10. The side shelf of claim 9 wherein the retention mechanism comprises the pivotal coupling between the cover and the base.

11. A barbecue grill comprising:
a structural component;
a side shelf that includes a base fixedly coupled to the structural component; and
a cover pivotally coupled to the base that pivots between a first position that substantially covers the base and a second position that substantially uncovers the base, wherein the cover in both the first and second positions is substantially horizontal.

12. A side shelf for a barbecue grill comprising:
a base coupled to the barbecue grill;
a cover; and
a plurality of pivot arms coupled to the base and cover, each pivot arm having a first end pivotally coupled to the base and having a second end pivotally coupled to the cover, wherein the plurality of pivot arms allow the base to pivot between a first position that substantially covers the base and a second position that substantially uncovers the base, wherein the cover in both the first and second positions is substantially horizontal.

13. The side shelf of claim 12 wherein the base includes a gas burner.

14. The side shelf of claim 12 wherein the base includes a storage container.

15. The side shelf of claim 12 wherein the cover includes a substantially flat top that may be used as a shelf in the first and second positions.

16. The side shelf of claim 12 wherein the plurality of pivot arms comprises four pivot arms.

17. A side shelf for a barbecue grill comprising:
a base coupled to the barbecue grill;
a cover; and
at least one hinge member coupled to the base and cover that allows the cover to pivot in a clamshell fashion with respect to the base and pivot between a first position that substantially covers the base and a second position that substantially uncovers the base, wherein the cover in both the first and second positions is substantially horizontal.

18. The side shelf of claim 17 wherein the base includes a gas burner.

19. The side shelf of claim 17 wherein the base includes a storage container.

20. The side shelf of claim 17 wherein the cover includes a substantially flat top portion that faces up when the cover is in the first position and a substantially flat bottom portion that faces up when the cover is in the second position.
